(19) United States
(12) Patent Application Publication
(10) Pub. No.: US 2015/0062068 A1
(43) Pub. Date: Mar. 5, 2015

(54) SENSING METHOD BASED ON CAPACITIVE TOUCH PANEL

(71) Applicant: TIANJIN FUNAYUANCHUANG TECHNOLOGY CO.,LTD., Tianjin (CN)

(72) Inventors: PO-SHENG SHIH, Hsinchu (TW); CHIEN-YUNG CHENG, Hsinchu (TW); CHIH-HAN CHAO, Hsinchu (TW); JIA-SHYONG CHENG, Hsinchu (TW)

(73) Assignee: TIANJIN FUNAYUANCHUANG TECHNOLOGY CO.,LTD., Tianjin (CN)

(21) Appl. No.: 14/164,099

(22) Filed: Jan. 24, 2014

(30) Foreign Application Priority Data
Aug. 30, 2013 (CN) 2013103869654

(51) Int. Cl. G06F 3/044

(52) U.S. Cl. CPC G06F 3/044
USPC 345/174

(57) ABSTRACT

A sensing method based on a capacitive touch panel is provided. The capacitive touch panel includes a touch sensor, a pressure sensor, and a deformable insulating layer disposed between the touch sensor and the pressure sensor to form a gap between the touch sensor and the pressure sensor. In the sensing method, at least one touch position is located using the touch sensor. Pressure information is sensed based on a number of self-capacitance variation values detected from the pressure sensor. The self-capacitance variation values are generated by a deformation of the deformable insulating layer under an external force.

### CROSS-REFERENCE TO RELATED APPLICATIONS

This application claims all benefits accruing under 35 U.S.C. §119 from China Patent Application No. 201310386965.4, filed on Aug. 30, 2013, in the China Intellectual Property Office, the disclosure of which is incorporated herein by reference.

### BACKGROUND

1. Technical Field

The present disclosure relates to sensing methods of touch panel, particularly to a sensing method based on a capacitive touch panel.

2. Description of Related Art

Conventional touch panels detect contact areas between the touch conductors and the capacitive touch panels to reflect pressure information. However, if hard touch conductors are used, the contact areas may be constant regardless of the external forces applied on the touch panels. Therefore, pressure information detection may be inaccurate, and operation errors triggered.

What is needed, therefore, is to provide sensing methods for solving the problem discussed above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic cross-sectional side view of an embodiment of a capacitive touch panel.

FIG. 2 is a schematic view of an embodiment of a first capacitive touch sensor and a second capacitive touch sensor of the capacitive touch panel.

FIG. 3 shows a schematic cross-sectional side view of another embodiment of the capacitive touch panel.

FIG. 4 is a schematic view of a morphological change of a deformable insulating layer of the capacitive touch panel from a non-pressed condition to a pressed condition.

FIG. 5 is a flowchart of an embodiment of a sensing method based on the capacitive touch panel.

FIG. 6 is a flowchart of one embodiment of a locating method of touch points based on the capacitive touch panel.

FIG. 7 is a flowchart of one embodiment of a method for obtaining a plurality of first sensing signal values in the method of FIG. 6.

FIG. 8 is a flowchart of one embodiment of the method for obtaining a first curve fitted by the plurality of first sensing signal values.

FIG. 9 is a flowchart of one embodiment of a method for sensing pressure information based on the capacitive touch panel.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

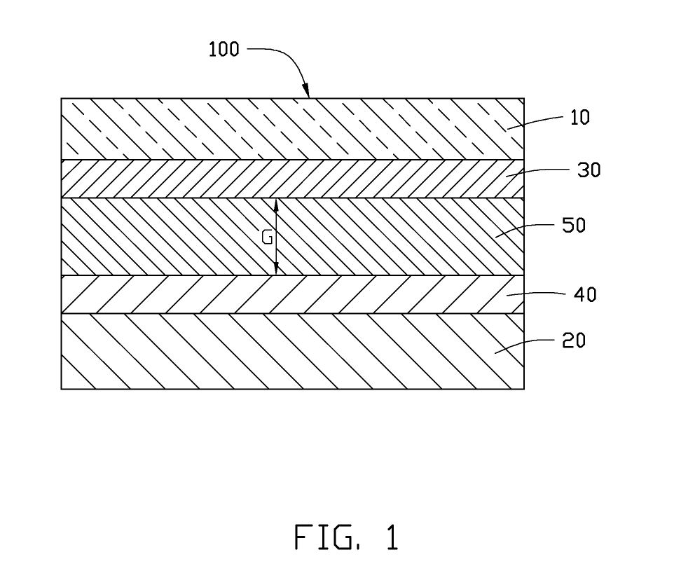

Referring to FIG. 1, one embodiment of a capacitive touch panel 100 includes a first substrate 10, a second substrate 20, a first capacitive touch sensor 30, a second capacitive touch sensor 40, and a deformable insulating layer 50. The first substrate 10 and the second substrate 20 are spaced from each other. The first capacitive touch sensor 30 is disposed on a surface of the first substrate 10 and located between the first substrate 10 and the second substrate 20. The second capacitive touch sensor 40 is disposed on a surface of the second substrate 20 and located between the first substrate 10 and the second substrate 20. The deformable insulting layer 50 is disposed between the first capacitive touch sensor 30 and the second capacitive touch sensor 40, whereby a gap G is formed between the first capacitive touch sensor 30 and the second capacitive touch sensor 40. A distance of the gap G changes if the deformable insulating layer 50 is deformed by a pressure.

The first substrate 10 and the second substrate 20 can be made of a transparent or opaque material. In one embodiment, the first substrate 10 and the second substrate 20 are made of transparent material. The transparent material can be glass, quartz, diamond, plastic, resin, polyethylene, polycarbonate, polyethylene terephathalate, polymethylmethacrylate, or combinations thereof. The first substrate 10 can be a protective layer for the capacitive touch panel 100. In one embodiment, the first substrate 10 is a flexible and transparent plate. A display module can be used as the second substrate 20. The display module is directly disposed on the second capacitive touch sensor 40 for displaying.

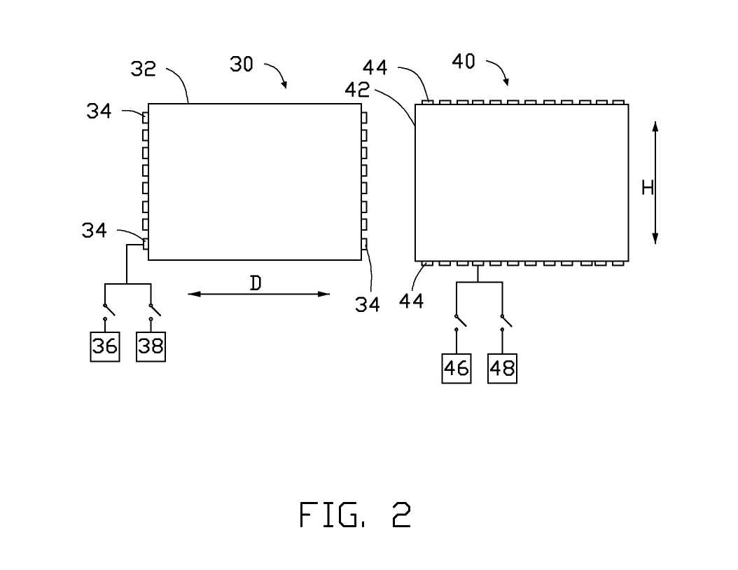

Referring to FIG. 1 and FIG. 2, the first capacitive touch sensor 30 only includes a single conductive film for generating sensing signals to realize a multi-touch detection. The first capacitive touch sensor 30 includes a first conductive film 32 and a plurality of first driving-sensing electrodes 34 electrically connected with the first conductive film 32.

The first conductive film 32 can be transparent or opaque. The first conductive film 32 can be an anisotropic impedance layer with continuous conductivity. Continuous conductivity means that a conductive network constituting a plurality of conductive traces electrically connected with each other can be formed on the first conductive film 32. The anisotropic impedance layer is a layer having a relatively low impedance direction D and a relatively high impedance direction H on the same surface (e.g., the surface of the first conductive film 32). The electrical conductivity of the anisotropic impedance layer on the relatively high impedance direction H is smaller than the electrical conductivities of the anisotropic impedance layer in other directions. The electrical conductivity of the anisotropic impedance layer on the relatively low impedance direction D is larger than the electrical conductivities of the anisotropic impedance layer in other directions. The relatively high impedance direction H is different from the relatively low impedance direction D. In one embodiment, the relatively high impedance direction H is substantially perpendicular to the relatively low impedance direction D. The relatively high impedance direction H and the relatively low impedance direction D of the anisotropic impedance layer can be achieved by having a plurality of conductive belts having a low conductivity aligned along the relatively high impedance direction H and a plurality of conductive belts having a high conductivity aligned along the relatively low impedance direction D, and the plurality of conductive belts having the low conductivity and the plurality of conductive belts having the low conductivity are electrically connected with each other. In another embodiment, the relatively high impedance direction H and the relatively low impedance direction D of the anisotropic impedance layer can be achieved by having a carbon nanotube film comprising orderly arranged carbon nanotubes. The first conductive film 32 can have a square shape having two sides substantially perpendicular to the relatively high impedance direction H and two sides substantially perpendicular to the relatively low impedance direction D. The anisotropic impedance layer with the continuous conductivity can generate a leakage current to achieve precise touch detection.

A material of the first conductive film 32 can be at least one of carbon nanotubes, indium tin oxide, metal, and graphene. The first conductive film 32 can be a transparent mesh, with the anisotropic impedance, made of the carbon nanotubes, indium tin oxide, metal, graphene, or combinations thereof.

The first conductive film 32 can be a carbon nanotube film. The carbon nanotube film comprises a plurality of carbon nanotubes orderly arranged. The plurality of carbon nanotubes are substantially aligned along a same direction so that the carbon nanotube film has a maximum electrical conductivity at the aligned direction of the carbon nanotubes which is greater than at other directions. The aligned direction of the plurality of carbon nanotubes is the relatively low impedance direction D. The carbon nanotube film can be formed by drawing the film from a carbon nanotube array. The overall aligned direction of a majority of the carbon nanotubes in the carbon nanotube film is substantially aligned along the same direction and substantially parallel to a surface of the carbon nanotube film. The carbon nanotube is joined to adjacent carbon nanotubes end to end by van der Waals force therebetween, and the carbon nanotube film is capable of being a free-standing structure. A support having a large surface area to support the entire free-standing carbon nanotube film is not necessary, and only a supportive force at opposite sides of the film is sufficient. The free-standing carbon nanotube film can be suspended and maintain its film state with only supports at the opposite sides of the film. When disposing (or fixing) the carbon nanotube film between two spaced supports, the carbon nanotube film between the two supports can be suspended while maintaining its integrity. The successively and aligned carbon nanotubes joined end to end by van der Waals attractive force in the carbon nanotube film is one main reason for the free-standing property. The carbon nanotube film drawn from the carbon nanotube array has good transparency. In one embodiment, the carbon nanotube film is substantially a pure film and consists essentially of the carbon nanotubes, and to increase the transparency of the touch panel, the carbon nanotubes are not functionalized.

The plurality of carbon nanotubes in the carbon nanotube film have a preferred orientation along the same direction. The preferred orientation means that the overall aligned direction of the majority of carbon nanotubes in the carbon nanotube film is substantially along the same direction. The overall aligned direction of the majority of carbon nanotubes is substantially parallel to the surface of the carbon nanotube film, thus parallel to the surface of the polarizing layer. Furthermore, the majority of carbon nanotubes are joined end to end therebetween by van der Waals force. In this embodiment, the majority of carbon nanotubes are substantially aligned along the same direction in the carbon nanotube film, with each carbon nanotube joined to adjacent carbon nanotubes at the aligned direction of the carbon nanotubes end to end by van der Waals force. There may be a minority of carbon nanotubes in the carbon nanotube film that are randomly aligned, but the number of randomly aligned carbon nanotubes is small compared to the majority of substantially aligned carbon nanotubes and therefore will not affect the overall oriented alignment of the majority of carbon nanotubes in the carbon nanotube film.

In the carbon nanotube film, the majority of carbon nanotubes that are substantially aligned along the same direction may not be completely straight. Sometimes, the carbon nanotubes can be curved or not exactly aligned along the overall aligned direction, and can deviate from the overall aligned direction by a certain degree. Therefore, it cannot be excluded that partial contacts may exist between the juxtaposed carbon nanotubes in the majority of carbon nanotubes aligned along the same direction in the carbon nanotube film. Despite having curved portions, the overall alignment of the majority of the carbon nanotubes are substantially aligned along the same direction.

The carbon nanotube film includes a plurality of successive and oriented carbon nanotube segments. The plurality of carbon nanotube segments are joined end to end by van der Waals attractive force. Each carbon nanotube segment includes a plurality of carbon nanotubes that are substantially parallel to each other, and the plurality of parallel carbon nanotubes are in contact with each other and combined by van der Waals attractive force therebetween. The carbon nanotube segment can have a desired length, thickness, uniformity, and shape. The carbon nanotubes in the carbon nanotube film have a preferred orientation along the same direction. The carbon nanotube wires in the carbon nanotube film can consist of a plurality of carbon nanotubes joined end to end. The adjacent and juxtaposed carbon nanotube wires can be connected by the randomly aligned carbon nanotubes. There can be clearances between adjacent and juxtaposed carbon nanotubes in the carbon nanotube film. A thickness of the carbon nanotube film at the thickest location is about 0.5 nanometers to about 100 microns (e.g., in a range from 0.5 nanometers to about 10 microns).

The carbon nanotube film has a unique impedance property because the carbon nanotube film has a minimum electrical impedance in the drawing direction, and a maximum electrical impedance in the direction substantially perpendicular to the drawing direction, thus the carbon nanotube film has an anisotropic impedance property. A relatively low impedance direction D is the direction substantially parallel to the aligned direction of the carbon nanotubes, and a relatively high impedance direction H is substantially perpendicular to the aligned direction of the carbon nanotubes. The carbon nanotube film can have a square shape with four sides. Two sides are opposite to each other and substantially parallel to the relatively high impedance direction H. The other two sides are opposite to each other and substantially parallel to the relatively low impedance direction D. In one embodiment, a ratio between the impedance at the relatively high impedance direction H and the impedance at the relatively low impedance direction D of the carbon nanotube film is equal to or greater than 50 (e.g., in a range from 70 to 500).

The plurality of first driving-sensing electrodes 34 are spaced with each other and arranged in a row along the relatively high impedance direction H. More specifically, the plurality of first driving-sensing electrodes 34 are space arranged on at least one side of the first conductive film 32, and the side is substantially perpendicular to the relatively low impedance direction D. In one embodiment, the plurality of first driving-sensing electrodes 34 are arranged on two opposite sides of the first conductive film 32, and the two sides are substantially perpendicular to the relatively low impedance direction D. A length along the relatively high impedance direction H of each first driving-sensing electrode 34 can be between about 1 mm to about 8 mm. A distance between the two adjacent first driving-sensing electrodes 34 can be between about 3 mm to about 5 mm. The plurality of first driving-sensing electrodes 34 can be made of at least one a metal, a conductive polymer, and a carbon nanotube layer including a plurality of carbon nanotubes. A signal, input by each first driving-sensing electrode 34 to the first conductive film 32 or received from the first conductive film 32, will transmit primarily along the relatively low impedance direction D.

The first capacitive touch sensor 30 further includes at least one first driving circuit 36 and at least one first sensing circuit 38 electrically connected with at least some of the plurality of first driving-sensing electrodes 34. The at least one first driving circuit 36 inputs driving signals to the first conductive film 32 via the at least some of the plurality of first driving-sensing electrodes 34. The at least one first sensing circuit 38 receives sensed signals via the at least some of the plurality of first driving-sensing electrodes 34. The at least one first driving circuit 36 can include a plurality of first driving circuits 36, and the at least one first sensing circuit 38 can include a plurality of first driving circuits 38. In one embodiment, each of the plurality first driving-sensing electrodes 34 is electrically connected with one first driving circuit 36 and one first sensing circuit 38.

The first capacitive touch sensor 30 as a touch sensor can realize multi-touch detection using only one conductive film. Other touch sensors with only one conductive film which can realize multi-touch detection can also be used in the capacitive touch panel 100. In addition, the touch sensing module can also be a capacitive touch sensor including two conductive films.

The second capacitive touch sensor 40 is a pressure sensor for detecting pressure information acted on the capacitive touch panel 100. Structures of the second capacitive touch sensor 40 and the first capacitive touch sensor 30 can be the same. The second capacitive touch sensor 40 can also include only one conductive film for sensing pressure. The pressure information can be detected by changes of self-capacitance sensed from the second conductive film 42 if the deformable insulating layer 50 is deformed. In one embodiment, the second capacitive touch sensor 40 includes a second conductive film 42 and a plurality of second driving-sensing electrodes 44 electrically connected with the second conductive film 42.

The second conductive film 42 can be the same as the first conductive film 32. In one embodiment, the second conductive film 42 is the anisotropic impedance layer. The relatively low impedance direction D of the second conductive film 42 is the same as that of the first conductive film 32, and the relatively high impedance direction H of the second conductive film 42 is the same as that of the first conductive film 32. In one embodiment, the relatively low impedance direction D of the second conductive film 42 is substantially perpendicular to the relatively high impedance direction H of the first conductive film 32. The plurality of second driving-sensing electrodes 44 are spaced from each other and arranged in a row along the relatively high impedance direction H of the second conductive film 42. More specifically, the plurality of second driving-sensing electrodes 44 are spaced and arranged on at least one side of the second conductive film 42, and the side is substantially perpendicular to the relatively low impedance direction D. In one embodiment, the plurality of second driving-sensing electrodes 44 are arranged on two opposite sides of the second conductive film 42, and the two sides are substantially perpendicular to the relatively low impedance direction D.

In one embodiment, the second conductive film 42 is a transparent and continuous conductive film. In one embodiment, a plurality of conductive belts constitute the second conductive film 42, and the plurality of conductive belts are spaced from each other and extend substantially along a same direction. In one embodiment, the second conductive film 42 is a continuous isotropic impedance layer. Isotropic impedance means that the impedance of the second transparent conductive film 42 is substantially uniform everywhere.

The second capacitive touch sensor 40 further includes at least one second driving circuit 46 and at least one second sensing circuit 48 electrically connected with at least some of the plurality of second driving-sensing electrodes 44. In one embodiment, each of the plurality second driving-sensing electrodes 44 is electrically connected with one second driving circuit 46 and one second sensing circuit 48. The second driving circuit 46 is the same as the first driving circuit 36 and the second sensing circuit 48 is the same as the first sensing circuit 38.

The first capacitive touch sensor 30 and the second capacitive touch sensor 40 work independently from each other. Therefore, touch positions and pressure information can be detected independently at the same time.

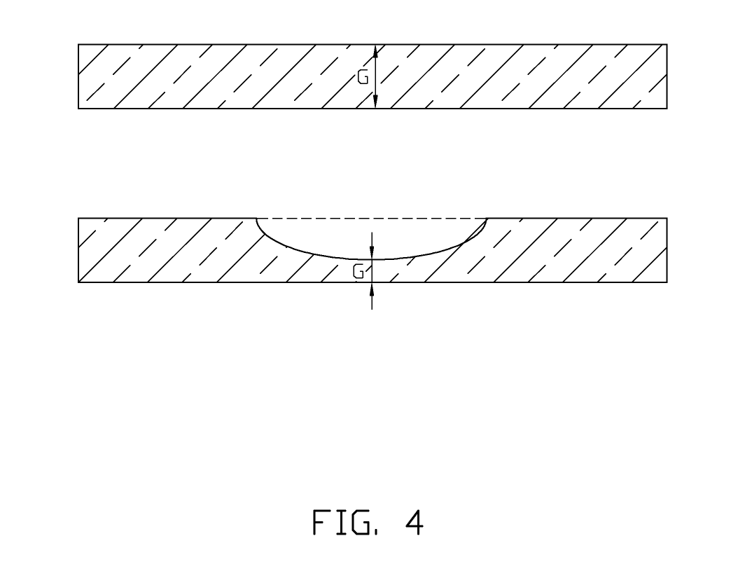

Referring to FIGS. 1-4, the deformable insulating layer 50 is disposed between the touch sensor and the pressure sensor. The deformable insulating layer 50 is deformable. The gap G changes with an external force applied on the deformable insulating layer 50. The decreased distance causes a self-capacitance sensed from the second conductive film 42 varied. The varied self-capacitance reflects the pressure information.

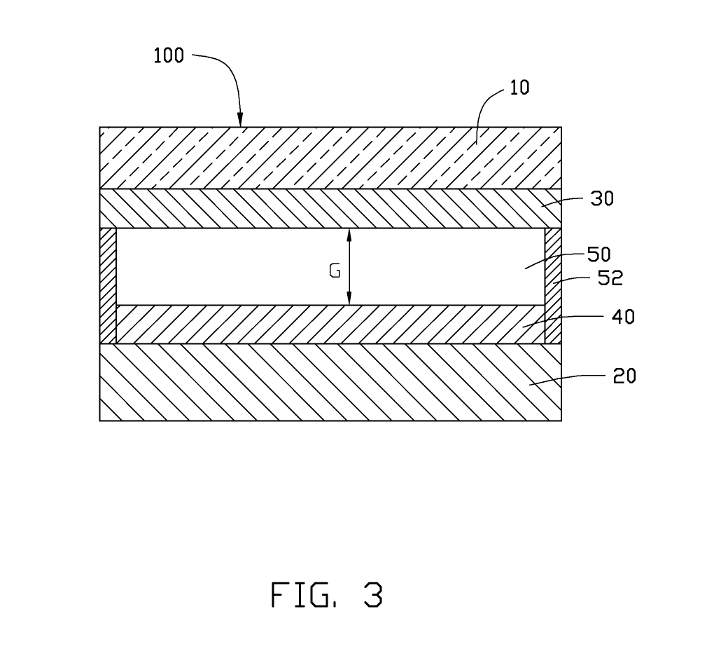

The deformable insulating layer 50 can be deformed by the external force and can restore to its former condition when the force vanishes. A material of the deformable insulating layer 50 can be at least one of a gas, liquid, liquid crystal material, solid elastic material, and combinations thereof. The elastic material can be a gel, such as a silica gel or acrylic gel. The liquid can be an ester. The gas can be air, nitrogen, inert gases, or combinations thereof. Referring back to FIG. 3, in one embodiment, the material of the deformable insulating layer 50 is a gas, the capacitive touch panel 100 further includes a support frame 52 disposed between the first conductive film 32 and the second conductive film 42 and supports peripheries of the first conductive film 32 and the second conductive film 42 to form a hermetic air cavity.

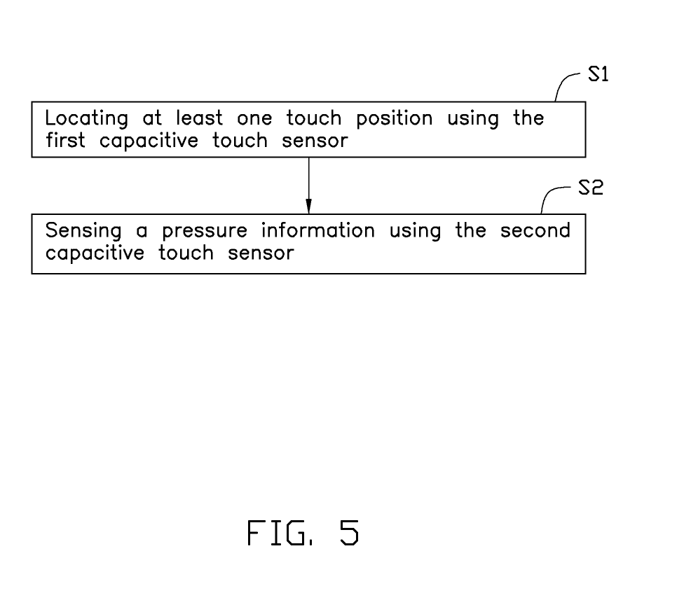

Referring to FIGS. 1-5, one embodiment of a sensing method based on the capacitive touch panel 100 includes the following steps:

S1, locating touch positions using the first capacitive touch sensor 30; and

S2, sensing the pressure information using the second capacitive touch sensor 40.

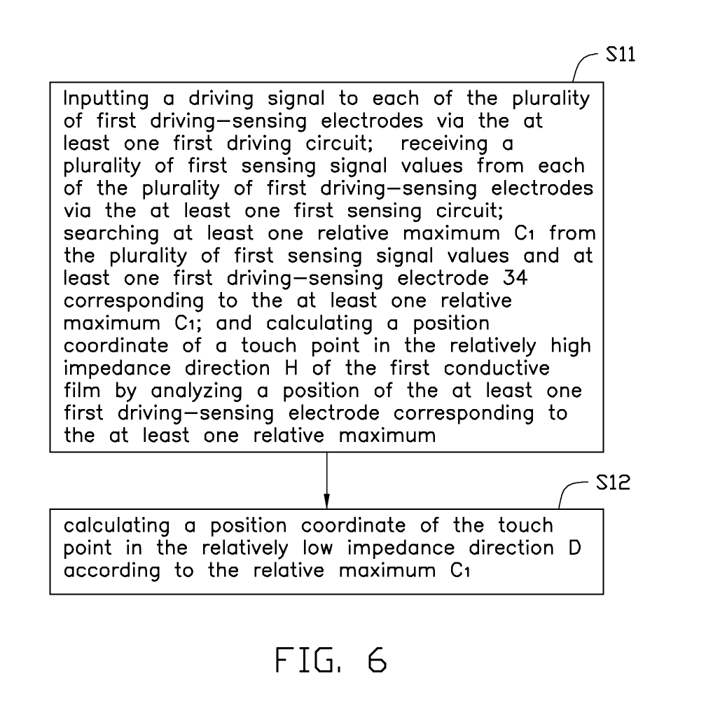

Referring to FIG. 6, the step S1 further includes the following substeps:

S11, inputting a driving signal to each of the plurality of first driving-sensing electrodes 34 via the at least one first driving circuit 36; receiving a plurality of first sensing signal values from each of the plurality of first driving-sensing electrodes 34 via the at least one first sensing circuit 38; searching at least one relative maximum C₁ from the plurality of first sensing signal values and at least one first driving-sensing electrode 34 corresponding to the at least one relative maximum C₁; calculating a position coordinate of a touch point in the relatively high impedance direction H of the first conductive film 32 by analyzing a position of the at least one first driving-sensing electrode 34 corresponding to the at least one relative maximum; and

S12, calculating a position coordinate of the touch point in the relatively low impedance direction D according to the relative maximum C₁.

In step S11, the plurality of first sensing signal values are capacitance variation values before and after touching the capacitive touch panel 100. The plurality of first sensing signal values can be fitted as a first curve showing a dependence of the first sensing signal values on the position of the first driving-sensing electrodes 34. If a multi-touch is applied on the capacitive touch panel 100, more than one relative maximum can be present in the first curve. The position coordinate of every touch point can be calculated using substeps S11-S12.

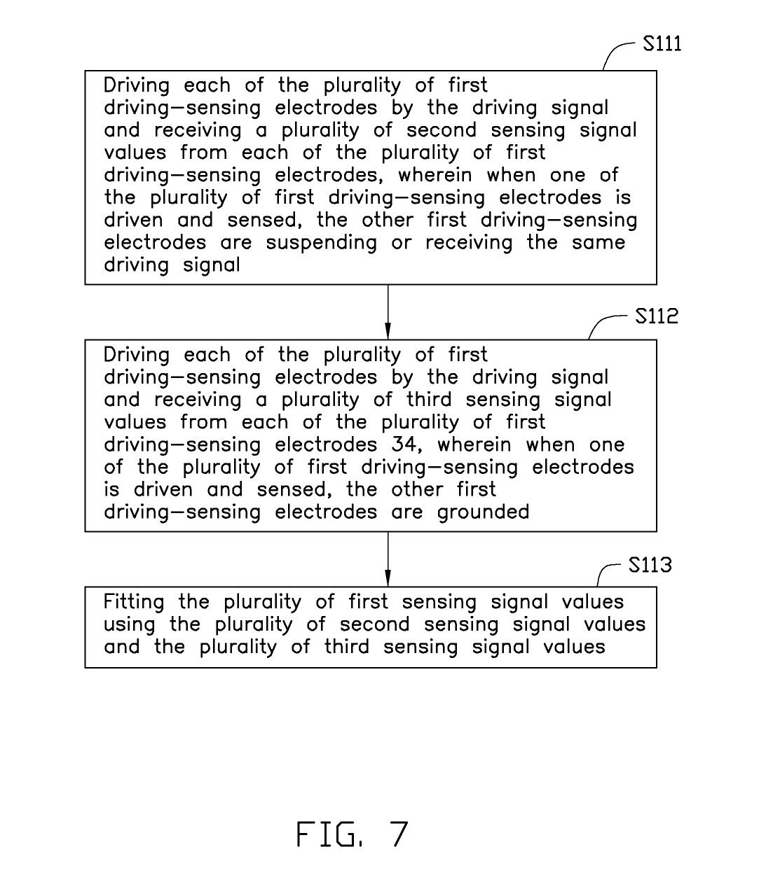

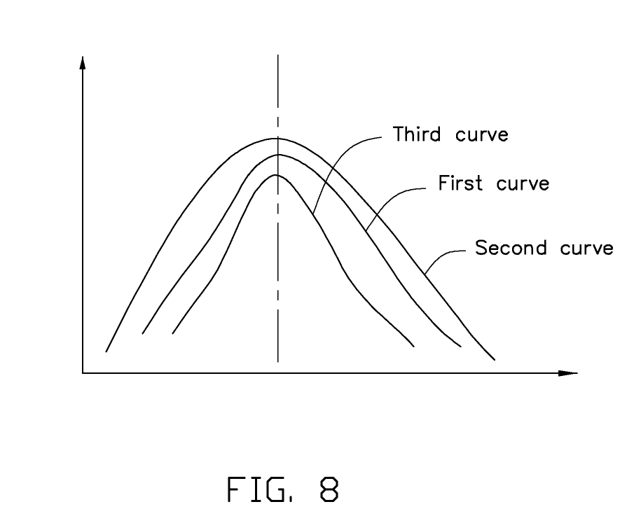

Referring to FIG. 7 and FIG. 8, the step S11 further includes the following substeps:

S111, driving each of the plurality of first driving-sensing electrodes 34 by the driving signal and receiving a plurality of second sensing signal values from each of the plurality of first driving-sensing electrodes 34, wherein when one of the plurality of first driving-sensing electrodes 34 is driven and sensed, the other first driving-sensing electrodes 34 are suspending or receiving the same driving signal;

S112, driving each of the plurality of first driving-sensing electrodes 34 by the driving signal and receiving a plurality of third sensing signal values from each of the plurality of first driving-sensing electrodes 34, wherein when one of the plurality of first driving-sensing electrodes 34 is driven and sensed, the other first driving-sensing electrodes 34 are grounded; and

S113, fitting the plurality of first sensing signal values using the plurality of second sensing signal values and the plurality of third sensing signal values.

In substeps S111 and S112, the plurality of first driving-sensing electrodes 34 can be orderly driven. The plurality of second sensing signal values can be fitted as a second curve showing a dependence of the second sensing signal values on the position of the first driving-sensing electrodes 34. The plurality of third sensing signal values can be fitted as a third curve showing a dependence of the third sensing signal values on the position of the first driving-sensing electrodes 34. The position coordinates of the touch point can be calculated based on the plurality of second sensing signal values (or the second curve) or the plurality of third sensing signal values (or the third curve). However, sometimes, touch errors can occur, whereby a detection precision of the position coordinates can be decreased only using the plurality of second sensing signal values or the plurality of third sensing signal values. The detection precision can be improved by fitting the plurality of first sensing signal values using the plurality of second sensing signal values and the plurality of third sensing signal values. In addition, the first curve can be fitted by the second curve and the third curve.

In substep S113, the second sensing signal value and the third sensing signal value sensed from the same first driving-sensing electrode 34 are defined as a sensing signal value pair. The fitting can be a weighted averaging process of the second sensing signal value and the third sensing signal value in each sensing signal value pair, to obtain the first sensing signal value for each first driving-sensing electrode 34.

In step S2, when the pressure information is being sensed, the first capacitive touch sensor 30 can work or not work.

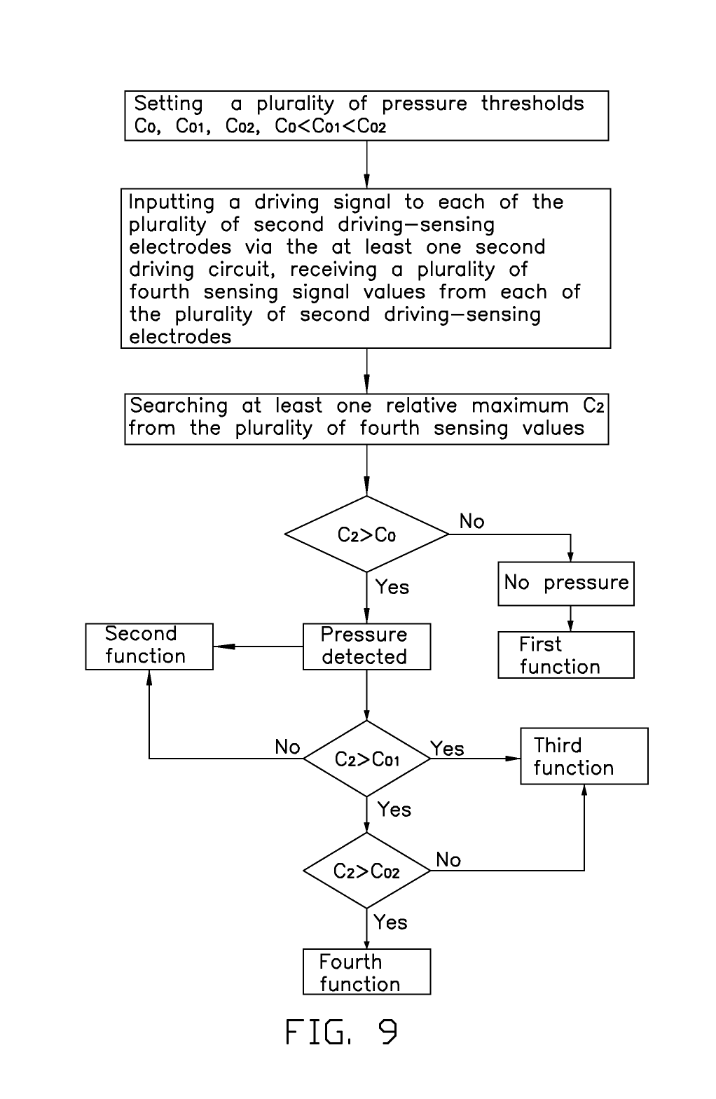

Referring to FIG. 9, the pressure information can be sensed by the following substeps:

S21, setting a pressure threshold C₀, the pressure threshold C₀ reflecting if there is a pressure applied on the capacitive touch panel 100;

S22, inputting a driving signal to each of the plurality of second driving-sensing electrodes 44 via the at least one second driving circuit 46, receiving a plurality of fourth sensing signal values from each of the plurality of second driving-sensing electrodes 44, and searching at least one relative maximum C₂ from the plurality of fourth sensing values; and

S23, judging if there is pressure applied on the capacitive touch panel 100 by comparing the at least one relative maximum C₂ with the pressure threshold C₀.

The pressure information can be detected by changes in the self-capacitance sensed from the second conductive film 42 when the deformable insulating layer 50 is deformed. The plurality of fourth sensing signal values are self-capacitance variation values during pressing the capacitive touch panel 100. The self-capacitance variation value can be a self-capacitance value difference or a self-capacitance value ratio, in which the self-capacitance values are detected before and after pressing the capacitive touch panel 100. The pressure information includes pressure values. The pressure information can further include pressure positions.

In substep S21, the pressure threshold C₀ is used to reflect whether there is a pressure applied on the capacitive touch panel 100. The pressure threshold C₀ can be an exact value. If the self-capacitance variation value sensed from the second capacitive touch sensor 40 is larger than the pressure threshold C₀, the pressure information is detected. If the self-capacitance variation value is smaller than or equal to the pressure threshold C₀, no pressure information is detected. In addition, the pressure threshold C₀ can also be a self-capacitance variation value range. If the self-capacitance variation value is within the range, the pressure information is detected. Otherwise, no pressure information is detected.

In substep S22, the plurality of fourth sensing signal values can be fitted as a fourth curve showing a dependence of the fourth sensing signal values on the position of the second driving-sensing electrodes 44. The plurality of fourth sensing signal values or the fourth curve can be used to reflect the pressure information.

In substep S23, if C₂<C₀, no pressure information is detected, and a first function can be triggered. The first function can be doing nothing or showing that the pressure is too small. If C₂>C₀, the pressure information is detected, and a second function can be triggered.

If the pressure information is detected, the pressure value reflecting the pressure information can be calculated. The self-capacitance variation value detected from the second capacitive touch sensor 40 can be used as or reflect the pressure value. In one embodiment, the pressure value is in direct proportion to the self-capacitance variation value.

The substep S21 further includes a step of setting a plurality of pressure thresholds C₀₁, C₀₂ . . . to reflect different pressure ratings, thereby to execute different functions. In one embodiment, C₀<C₀₁<C₀₂, if C₀<C₂<C₀₁, a light pressing is detected, the second function can be triggered. If C₀₁<C₂<C₀₂, a medium strength pressing is detected, a third function can be triggered. If C₂>C₀₂, a heavy strength pressing is detected, a fourth function can be triggered. The second function, third function, and fourth function can be some gestures, such as tuning the volume up or down, dragging icons or pictures, or displaying right-click context menu.

In step S2, the pressure position is the touch position of the touch point. Therefore, if the touch position is calculated by the first capacitive touch sensor 30, only those second driving-sensing electrodes 44 corresponding to the touch position can be driven and sensed to obtain the at least one relative maximum C₂. Therefore, the pressure information can be quickly fixed.

The capacitive touch panel 100 includes the touch sensor and the pressure sensor. The touch sensor is achieved by the first capacitive touch sensor 30. The pressure sensor is achieved by the second capacitive touch sensor 40. The touch position and the pressure information can be detected independently and at the same time. Structures of the second capacitive touch sensor 40 and the first capacitive touch sensor 30 can be the same. Therefore, the pressure sensor can also detect the touch position, and the detection precision of the pressure information by the pressure sensor can be increased.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A sensing method based on a capacitive touch panel, the capacitive touch panel
comprising:
a first substrate;
a second substrate spaced from the first substrate;
a first capacitive touch sensor disposed on a surface of the first substrate and located between the first substrate and the second substrate, the first capacitive touch sensor comprising a first conductive film;
a second capacitive touch sensor disposed on a surface of the second substrate and located between the first substrate and the second substrate, the second capacitive touch sensor comprising a second conductive film; and
a deformable insulating layer disposed between the first capacitive touch sensor and the second capacitive touch sensor to form a gap between the first conductive film and the second conductive film, wherein a distance between the first conductive film and the second conductive film changes along with a deformation of the deformable insulating layer;
the sensing method comprising:
locating at least one touch position using the first capacitive touch sensor; and
sensing a pressure information using the second capacitive touch sensor.

2. The method of claim 1, wherein the first capacitive touch sensor is a single-layered structure comprising only one first conductive film and the second capacitive touch sensor is a single-layered structure comprising only one second conductive film.

3. The method of claim 1, wherein the first conductive film is an anisotropic impedance layer with continuous conductivity, the anisotropic impedance layer has a relative low impedance direction, an electrical conductivity of the anisotropic impedance layer on the relatively low impedance direction is larger than the electrical conductivities of the anisotropic impedance layer in other directions, the first capacitive touch sensor further comprising a plurality of first driving-sensing electrodes spaced and arranged on at least one side of the first conductive film, substantially perpendicular to the relatively low impedance direction, the locating step further comprising:
inputting a driving signal to each of the plurality of first driving-sensing electrodes;
receiving a plurality of first sensing signal values received from the each of the plurality of first driving-sensing electrodes;
searching at least one relative maximum from the plurality of first sensing signal values and at least one first driving-sensing electrode corresponding to the at least one relative maximum;
calculating a position coordinate of a touch point in the relatively high impedance direction of the first conductive film by analyzing a position of the at least one first driving-sensing electrode corresponding to the at least one relative maximum; and
calculating a position coordinate of the touch point of in a direction substantially perpendicular to the relatively low impedance direction according to the at least one relative maximum.

4. The method of claim 3, wherein the plurality of first sensing signal values are obtained by the following steps:
driving each of the plurality of first driving-sensing electrodes by the driving signal and receiving a plurality of second sensing signal values from each of the plurality of first driving-sensing electrodes, wherein when one of the plurality of first driving-sensing electrodes is driven and sensed, the other first driving-sensing electrodes are suspending or receiving the same driving signal;
driving each of the plurality of first driving-sensing electrodes by the driving signal and receiving a plurality of third sensing signal values from each of the plurality of first driving-sensing electrodes, wherein when one of the plurality of first driving-sensing electrodes is driven and sensed, the other first driving-sensing electrodes are grounded; and
fitting the plurality of first sensing signal values using the plurality of second sensing signal values and the plurality of third sensing signal values.

5. The method of claim 4, wherein the second sensing signal value and the third sensing signal value sensed from the same first driving-sensing electrode is defined as a sensing signal value pair, the fitting step is a weighted averaging process of the second sensing signal value and the third sensing signal value in each sensing signal value pair to obtain the first sensing signal value for each of the plurality of first driving-sensing electrodes.

6. The method of claim 3, wherein the second conductive film is the anisotropic impedance layer, the second capacitive touch sensor further comprising a plurality of second driving-sensing electrodes space arranged on at least one side of the second conductive film, substantially perpendicular to the relatively low impedance direction of the second conductive film, and the pressure information is sensed by the following steps:
setting at least one pressure threshold reflecting whether there is a pressure applied on the capacitive touch panel;
inputting a driving signal to each of the plurality of second driving-sensing electrodes, receiving a plurality of fourth sensing signal values from each of the plurality of second driving-sensing electrodes, and searching at least one relative maximum from the plurality of fourth sensing values; and
judging if there is the pressure applied on the capacitive touch panel by comparing the at least one relative maximum of fourth sensing values with the pressure threshold, when the at least one relative maximum of fourth sensing values<the pressure threshold, no pressure information is detected, and when the at least one relative maximum of fourth sensing values>the pressure threshold, the pressure information is detected.

7. The method of claim 6 further comprising setting a plurality of pressure thresholds to reflect different pressure ratings and to execute different functions.

8. The method of claim 6, wherein the relatively low impedance direction of the second conductive film is substantially perpendicular to that of the first conductive film.

9. The method of claim 6, wherein the relatively low impedance direction of the second conductive film is substantially parallel to that of the first conductive film.

10. The method of claim 1, wherein the first capacitive touch sensor is not worked during sensing the pressure information.

11. The method of claim 1, wherein the touch position is located based on a plurality of first self-capacitance variation values sensed from the first conductive film and the pressure information is sensed based on a plurality of second self-capacitance variation values sensed from the second conductive film.

12. The method of claim 1, wherein each of the first conductive film and the second conductive film is a free-standing carbon nanotube film.

13. The method of claim 1, wherein a material of the deformable insulating layer is selected from the group consisting of gas, liquid, liquid crystal material, solid elastic material, and combinations thereof.

14. A sensing method based on a capacitive touch panel, the capacitive touch panel comprising:
a touch sensor comprising a first conductive film;
a pressure sensor comprising a second conductive film; and
a deformable insulating layer disposed between the touch sensor and the pressure sensor to form a gap between the touch sensor and the pressure sensor;
the sensing method comprising:
locating at least one touch position using the touch sensor; and
sensing a pressure information using a plurality of self-capacitance variation values detected from the second conductive film of the pressure sensor, the plurality of self-capacitance variation values being generated by a deformation of the deformable insulating layer under an external force.

15. The method of claim 14, wherein the second conductive film is an anisotropic impedance layer with continuous conductivity, the anisotropic impedance layer has a relative low impedance direction, and an electrical conductivity of the anisotropic impedance layer on the relatively low impedance direction is larger than the electrical conductivities of the anisotropic impedance layer in other directions.

16. The method of claim 15, wherein the first conductive film is the anisotropic impedance layer, and the relative low impedance direction of the first conductive film is substantially perpendicular to that of the second conductive film.

17. The method of claim 14, wherein the second conductive film is a patterned conductive film comprising a plurality of conductive belts, the plurality of conductive belts are spaced each other and extend substantially along a same direction.

18. The method of claim 14, wherein the second conductive film is a continuous isotropic impedance layer, the isotropic impedance having the same impedance at positions along length and width directions of the second transparent conductive film.
